(19) United States
(12) Patent Application Publication
(10) Pub. No.: US 2012/0175304 A1
(43) Pub. Date: Jul. 12, 2012

(54) METHOD AND DEVICE FOR TRANSFERRING MASS BETWEEN TWO FLUIDS

(75) Inventors: Benjamin Brocades Zaalberg, Bussum (NL); Franciscus Antonius Pronk, Eindhoven (NL)

(73) Assignee: FluXXion B.V., Eindhoven (NL)

(21) Appl. No.: 13/320,143

(22) PCT Filed: May 11, 2010
(86) PCT No.: PCT/NL2010/000078

§ 371 Date: Mar. 26, 2012

(30) Foreign Application Priority Data
May 11, 2009 (NL) 2002870

(51) Int. Cl. B01D 19/00; B01D 61/36

(52) U.S. Cl. 210/640; 261/100; 261/23.1; 261/21

(57) ABSTRACT

A mass transfer device, such as a desorption device has fluid channels, to transfer a component one fluid to the other. A microsieve is provided separating the channels. The microsieve comprising a sieve layer with a thickness of less than two micrometer deposited on a substrate with openings to expose areas of the sieve layer with holes straight through the sieve layer. The remaining portions of the substrate form a support web to support the sieve layer. In an embodiment the liquid channel is provided on the side of the microsieve opposite the substrate portions. An efficient very low height (e.g. 25 micrometer) liquid channel may be realized in this way. Preferably the liquid is supplied using a channel plate facing the microsieve, with grooves opposite wider portions of the substrate, the liquid flowing out sideways from the grooves into areas where the low height liquid channel is formed.

### FIELD OF THE INVENTION

The invention relates to a method and device for performing mass transfer between flows of a first and second fluid, such as desorbing a component from a liquid into a gas. Among others a method and micro structured contacting device are provided to bring into contact two fluids in efficient mass transfer processes.

### BACKGROUND

Mass transfer processes make use of non-equilibrium between concentration of one or more substances (components) in two fluids, for instance a liquid and a gas phase fluid, to transfer an amount of the mass of one or more substances between the fluids, for instance from either the liquid to the gas (desorption) or the gas to the liquid (absorption). In case of distillation use is made of the net mass transfer of one or more volatile substances from the liquid to the gas phase due to vapor pressure differences.

Well known examples of mass transfer processes are absorption, desorption and distillation. In order to realize high efficiency, for instance distillation columns are known wherein the liquid flows in a film and a gas flow is lead along this film to carry away the transferred component from the liquid. However, distillation columns are complex and voluminous devices.

US 2008/0275653 describes a microfluidic device that performs desorption. This device has also been described in an article titled “Analysis of a toluene stripping process: a comparison between a microfabricated stripping column and a conventional packed tower”, by Stephen H. Cypes et al in the Chemical Engineering Journal 101 (2004) pages 49-56. The microfluidic device comprises two chips of silicon wafers that are attached to each. In one of the chips a permeable wall is realized between channels for the liquid and the gas phase. Adjacent this permeable wall, the other chip contains a groove that forms a fluid channel. The chips are made from a silicon wafer, wherein the holes are defined photolithographically and etched through the silicon in a portion of the silicon whether its thickness has been reduced by etching.

In the device of Cypes et al. this permeable wall has a thickness of 70 micrometer with holes of 10 micrometer diameter length and width. Use of such a permeable wall has been found to counteract mixing between the two phases, which may be a problem especially in a flow desorption process, wherein the phases flow through a desorption chamber. Diffusion from the liquid to the gas phase and in the liquid due to disequilibrium provides for desorption and not flow through the holes. The permeable wall serves to prevent that liquid flows into the space for the gas phase or vice versa, provided at least that there is no excessive pressure difference between the liquid and the gas phase.

Although Cypes et al report an order of magnitude better mass transfer capacity than conventional devices, there are limits on the efficiency and maximum relative liquid mass load of the device used by Cypes et al. In principle the transfer capacity per unit area is proportional to the aggregate exposed area of liquid gas interface. That is, proportional to the aggregate hole area per unit area of the permeable wall. But there is an upper limit to the aggregate hole area that can be realized. Of course the aggregate hole area in a unit area cannot exceed the unit area and moreover, a certain amount of area is inevitably lost to the wall surface around the holes, to provide mechanical strength. Also, the size of the holes cannot be made too large, because overly large holes would allow the phases to mix due to pressure differences between the liquid and the gas phase that are inevitably needed to create flow.

U.S. Pat. No. 7,118,711 describes a microcolumn reactor. A microcolumn reactor has a construction like a chromatograph, with in this case a microbead filled channel through which a fluid is made to flow. U.S. Pat. No. 7,118,711 describes a micro reactor comprising two substrate wafers, one with a microbead-filled channel in its surface and the other with passage openings at a number of positions opposite the channel. A partially permeable sieve-like membrane separates the passage openings from the channel. U.S. Pat. No. 7,118,711 mentions a porous membrane of siliconoxinitride. Thus the passage holes function as permeate output of a cross-flow like filter arrangement. The document does not provide for two fluids that flow in parallel on either side of the membrane. A cross-flow filter is also described in US 2007/0068865.

DE 19639965 describes a desorption device with a membrane between two fluids. Hollow fiber membranes are used, which are relatively thick and have tortuous passages through the membranes leading inevitably to relative lower mass transfer efficiency.

### SUMMARY

Among others it is an object to increase the efficiency of mass transfer between separately flowing fluids, such as desorption, absorption or distillation.

A device according to claim 1 is provided. Herein a microsieve is used to realize transfer between two flowing fluids, such as a liquid and a gas phase. Manufacture of such microsieves is known per se for example from EP0728034 and EP1667788. In a microsieve a very thin deposited layer on a substrate is used as a sieve layer. A layer of silicon nitride on a silicon substrate may be used for example. A thickness of less than two micrometer is used. The layer thickness may be at least 0.2 micrometer and more preferably at least 0.4 micrometer for example. The substrate is partly removed to provide openings in areas of the sieve layer that contain sieve holes, leaving remaining substrate portions to support the sieve layer. In the microsieve, the sieve holes run straight through the sieve layer. As used herein holes created directly or indirectly by etching at photo-lithographically defined locations are embodiments of holes straight through the sieve layer.

It has been found that it is possible to keep the fluids on opposite sides of such a microsieve separate and that the use of the very thin sieve layer with microscopic holes straight through the sieve layer made of a microsieve makes it possible to increase the mass transfer efficiency, such as desorption efficiency. Although the maximum achievable fraction of aggregate hole area per unit area of the microsieve may be expected to be less than is possible with thicker sieve layer, the use of a very thin layer makes it possible to make more efficient use of the holes in the sieve layer. Diffusion through the membrane is less of a limiting factor to mass transfer, such as desorption. Moreover, such a sieve layer is very flat, making it possible to use a first fluid channel, for example for a liquid, over the sieve layer that has very small height, which reducing the limiting effect diffusion even more.

It was found that with the use of micro sieves between e.g. a gas and liquid phase the overall mass transfer rate of components between the phases is already optimal if approximately 50% of the sieve layer that is in contact with the fluids contains sieve holes.

Preferably a sieve layer is used that contains pores with mutually equal diameter, equal height and equal shape. This is unlike conventional membranes which are characterized by wide pore size distributions and tortuous paths through the membrane. The diameter is the largest distance between the walls of the pore measured in a plane parallel to the main surface of the sieve layer. Circular pores or rectangular pores may be used. A sub-micron diameter may be used, for example between 0.2 and 1 micrometer, or diameter of 1-4 micrometer for example.

In an embodiment liquid is supplied to the sieve layer from a liquid inlet that feeds into a channel, the mass-transfer channel (mt-channel), over the surface of the feed layer that faces away from the supporting substrate portions on which the sieve layer is deposited. Thus, the limiting effect of the substrate on the channel height can be avoided specifically for the liquid, which has been found to provide for higher efficiency. Of course a higher channel height will result for the gas phase, but it has been found that reduction of the channel height for the liquid is more determinative for avoiding the limiting effect of diffusion than reduction of the channel height of the gas as long as this height is less than 1000 micrometer, preferably less than 700 micrometer and more preferably less than 500 micrometer.

A liquid channel height between 10 and 300 micrometer and more preferably less then 100 micrometer, and more preferably less than 50 micrometer may be used for example, such as 25 micrometer or between between 10 and 100 micrometer or between 10 and 50 micrometer. As a result a mt-channel length in the order of ten millimeter may suffice to provide high rates of mass transfer such as desorption.

In an embodiment the mt-channel for the liquid is realized by using a channel plate facing the surface of the sieve layer that faces away from the substrate portions that support the deposited sieve layer. As used herein, a channel plate is a plate with a surface that, together with the sieve layer defines a channel located between the sieve layer and the channel plate. In an embodiment this channel plate may have protrusions in contact with the microsieve to define the height of the channel between the channel plate and areas of the sieve layer that contain holes. In an embodiment this is the lowest height of the channel plate over the sieve layer, except at the protrusions. In an embodiment the channel plate may comprise grooves that define supply channels of greater height between the liquid inlet and/or outlet and the mt-channels over the holes. Preferably, these grooves are located over parts of the sieve layer opposite which substrate portions support the sieve layer. Thus low height channels can be realized over the areas with holes with little loss of efficiency. Successive grooves may be used alternately for supplying and removing liquid.

In another embodiment a foil is used with a structured pattern in which the remaining parts form the protrusions defined above thus forming the mt-channels by the openings in this foil. The supply channels are still realized in the channel plate however the manufacturing of this plate is thus much easier to realize while the structured foils can be manufactured in a very efficient way.

In an embodiment the device comprises a further channel plate located facing the substrate and the second surface of the sieve layer to define a space and flow paths for the gas preferably gas flow directions adjacent the areas with holes are used that are opposite to the liquid flow directions adjacent those areas.

In an embodiment a hydrophobic layer or a hydrophilic layer is used is used. This hydrophilic or a hydrophobic layer is used dependent on the surface tension of the liquid phase. The layer is realized by either deposition on or surface treatment of the sieve layer on the surface of the sieve layer opposite the supporting substrate and at least part of a wall of the holes through the sieve layer. This raises the maximum pressure that can be realized to drive the flow.

In an embodiment a method of desorbing a component from a flowing liquid into a gas stream is provided, the method comprising creating flows of the liquid and the gas on mutually opposite sides of a microsieve with a sieve layer with a thickness of less than two micrometer deposited on a substrate with openings to expose areas of the sieve layer with holes through the sieve layer. Thus a high efficiency of mass transfer can be realized. In a further embodiment the liquid is fed into a channel adjoining a first surface of the sieve layer, the first surface lying opposite a second surface of the sieve layer that is supported by the substrate, sieve holes running from the first surface to the second surface. This makes it possible to desorb the component from the liquid even more efficiently. In a further embodiment the liquid may be fed into the channel sideways from a further channel of greater height than the channel, the further channel facing substantially only a part of the first surface of the sieve layer opposite which the sieve layer is supported by the substrate. Thus a substantial amount of liquid can be supplied while sacrificing little or none of the sieve area and without compromising sieve strength.

### BRIEF DESCRIPTION OF THE DRAWING

These and other objects and advantageous aspects will become apparent from a description of exemplary embodiments, using the following figures.

FIG. 1 shows a device with a mass transfer channel

FIG. 2 shows a first cross-section of a mass transfer unit

FIG. 3 shows a second cross-section of a mass transfer unit

FIG. 4 shows a top view of a mass transfer unit

FIG. 5 shows a stacked device

### DETAILED DESCRIPTION OF EXEMPLARY EMBODIMENTS

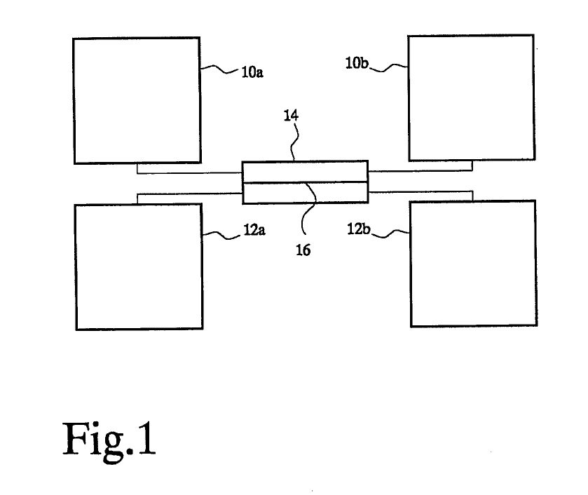

FIG. 1 shows a device with a separation channel. The device comprises a liquid source 10a, a liquid sink 10b, a gas source 12a and a gas sink 12b and a mass transfer unit 14 with a microsieve 16. Mass transfer unit 14 may be a separation unit used to provide contact between gas and liquid but to prevent mixing. Microsieve 16 comprises a thin layer of material with a first and second surface (e.g. less than a few micrometers thick between the surfaces) with holes running through the layer from the first surface to the second surface. Liquid source 10a and liquid sink 10b are coupled to an inlet and outlet of a first space formed adjacent the first surface of microsieve 16. Gas source 12a and gas sink 12b are coupled to an inlet and outlet of a second space adjacent the second surface of microsieve 16. In operation liquid source 10a and liquid sink 10b provide for a liquid flow along the first surface microsieve 16. Gas source 12a and gas sink 12b provide for a gas flow along the second surface of microsieve 16. Preferably, counterflow is realized, i.e. liquid and gas flow in mutually opposite directions along mutually opposite surfaces of mircosieve 16.

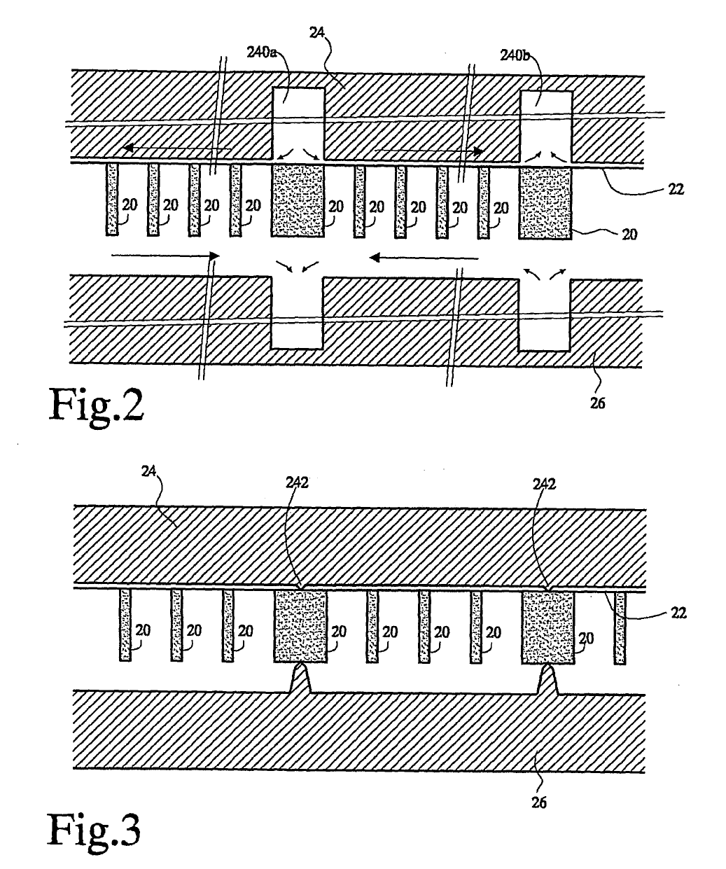

FIG. 2 shows a cross-section of mass transfer unit 14 in more detail (not to scale). Mass transfer unit 14 comprises the microsieve 16, a first channel plate 24 and a second channel plate 26. Microsieve 16 is located between first channel plate 24 and second channel plate 26. Microsieve 16 comprises a web of substrate portions 20 of a substrate, and a sieve layer 22 supported on this web. Substrate portions 20 may have a height of 675 micrometer for example. The cross-section shows only part of this web.

Microsieve 16 may be manufactured starting from a silicon substrate, by growing sieve layer 22 on the substrate and photolithographically etching a pattern of holes into sieve layer 22. A layer of silicon nitride may be used for example. Subsequently, much larger diameter openings were etched in the substrate by etching from the side of the substrate opposite to layer 22, leaving the web of substrate portions 20. The openings in the silicon substrate may also be etched either partly of fully through the holes in the sieve layer 22 thus enabling easy alignment of the support structure in the silicon substrate and the sieve area's. In other examples, the thin silicon nitride sieve layer may be replaced another type of layer that responds more slowly to certain etchants, so that the silicon can be selectively removed. Examples of possible replacements include a poly-silicon layer, or a layer with added doping or a polymer. In another example a metal layer may be used. An electrodeposited layer may be used. Instead of etching the holes through the sieve layer, the holes may be realized when the layer is grown, by producing a photolithographically structured activation layer before growing the sieve layer for example, or by first providing for material at the locations of the holes, with at least the height of the sieve layer and later selectively removing this material.

The distance between substrate portions 20 may be between 100 micrometer and 500 micrometer for example, say 150 micrometer, leaving areas of sieve layer 22 with holes and without support by substrate portions along this distance. This technique allows for the use of an extremely thin sieve layer 22 and for holes of uniform very small diameter. In one embodiment a layer thickness of 0.8 micrometer was used, with an array of circular holes, each with a diameter of 0.45 micrometer. Holes with a diameter between 0.2 micrometer and 5 micrometer may be used for example, and preferably between 0.4 micrometer and 2 micrometer, with aggregate hole size per unit area for the sieve area's with holes of up to a fraction of 0.4 of the unit area for example, a fraction of 0.2 may be used for example. A sieve layer thickness between 0.2 and 2 micrometer and preferably between 0.4 and 2 micrometer may be used.

The web of substrate portions provides strength to this fragile structure. The cross-section shows only part of this web. Preferably, the web contains support structures at a number of different scales. The wafer on which the sieve layer is formed may have a diameter of more than 100 millimeter. A large scale structure may be provided with substrate portions that are several millimeters wide, defining large scale blocks (e.g. about 10×10 millimeter wide) between the substrate portions of this level, the blocks containing substrate portions at a finer scale and sieve portions where sieve layer 22 is not supported by substrate portions. A finer scale structure may be provided with substrate portions that are about half a millimeter wide, defining fields between the substrate portions of this level at a smaller scale than the blocks, the fields containing substrate portions at a finer scale and sieve portions where sieve layer 22 is not supported by substrate portions. In turn an even finer scale structure may be provided with substrate portions that are about fifty to a hundred microns wide, defining membrane areas between the substrate portions of this level at a smaller scale than the fields, the sieve layer 22 being unsupported by substrate portions in the membrane areas. The substrate portions extend in various directions to provide for effective support.

In cross-sections in any direction one will always encounter a series of substrate portions 20, including substrate portions 20 at the finest scale and possibly substrate portions at coarser scale. By way of example the figure shows some of the substrate portions of the finest scale and at a coarser scale. It should be understood that in practice many more substrate portions at the finest scale will occur between portions at the coarser scale. As shown in the cross-section, substrate portions 20 provide for a succession of exposed sections of sieve layer 22, separated by sections that are supported by substrate portions 20.

First channel plate 24 comprises grooves 240a, b at least partly in parallel with each other, overlying parts of the sieve layer 22 that are supported by coarser substrate portions. In an embodiment, grooves 240a, b have substantially the same width as these substrate portions. In one embodiment grooves 240a, b overlie parts of the sieve layer 22 that are supported by the coarsest substrate portions with a width of at least one millimeter. The distance between successive grooves 240a, 240b corresponds to the distance between relatively wide substrate portions 20 that are part of the coarser level of the support. The distance between successive grooves 240a, b is 11 millimeter for example thus defining the mass transfer channel length. The distance between the grooves can however be chosen depending on application of the device. Between grooves 240a, b the surface of first channel plate 24 lies at a distance of 25 micrometer from the surface of sieve layer 22 opposite the surface that carries substrate portions 20. Between grooves 240a, b and their underlying substrate portions 20, sieve layer 22 is preferably supported by at least one further substrate portion 20 and preferably by a plurality of further substrate portions 20. Although four such further substrate portions 20 are shown in the figure, it should be appreciated that many more may be present. In this embodiment unsupported areas of sieve layer 22 with holes are provided along the flow path between grooves 240a, b in between the further substrate portions 20 and/or between at least one of the further substrate portions and the substrate portions 20 underlying grooves 240a, b. This protects sieve layer 22. The height and/or width of grooves 240a, b may taper along their length.

FIG. 3 shows a cross-section in a transverse to the direction of the cross-section of FIG. 2. First channel plate 24 has protrusions 242 by which first channel plate 24 contacts sieve layer 22. Protrusion 242 define the distance between the surface of first channel plate 24 and the surface of sieve layer 22 at positions where no grooves or protrusions are present. Preferably, protrusions 242 extend as continuous ridges (not necessarily straight) between successive grooves 240, to define separations between liquid channels. Alternatively, protrusions 242 may form interrupted ridges. Alternatively the protrusions may be formed by a separate foil which will be mounted between the channel plate 24 and the surface of the substrate.

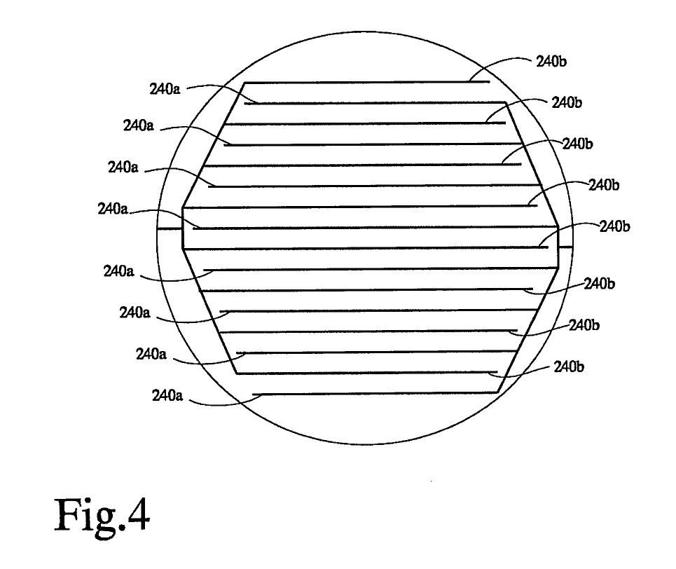

FIG. 4 shows a top view. Grooves 240a, b define liquid supply channels, alternately for liquid to be processed from the liquid source (not shown) and for processed liquid flowing to the liquid sink (not shown). Two comb-pattern sets of supply channels are used, with interdigitated “teeth” of the combs.

In operation liquid is supplied from a liquid source (not shown) to a first set of grooves 240a in first channel plate 24. The liquid flows through the grooves, leaking out sideways into liquid-channels between sieve layer 22 and the surface of first channel plate 24, as indicated by arrows in FIG. 2. From there the liquid flows along sieve layer 22 to adjacent grooves 240b of a second set of grooves that alternate with the grooves of the first set. The liquid flows to the liquid sink via the grooves 240b of the second set. Although the common parts of the comb (the backbone) are shown in the same way as grooves 240a, b, it should be understood that they may in fact be wider, or even open area.

The structure of second channel plate 26 is similar to that of first channel plate 24. Second channel plate 26 has protrusions in contact with the side of the substrate portions 20 that face away from sieve layer 22. Preferably the grooves in first and second channel plate 24, 26 run along the same substrate portions only. In operation, gas flows from a first set of grooves in second channel plate 26 to the space between second channel plate 26 and sieve layer 22 and from there to a groove of second set in second channel plate 26. Preferably, counterflow is realized, i.e. liquid and gas flow in mutually opposite directions along the surface of sieve layer 22, as shown by arrows, by coupling the liquid source and sink and the gas source and sink in mutually opposite sequence to either surface of sieve layer 22.

As may be noted, the height of the liquid channel along sieve layer 22, between sieve layer 22 the surface of first channel plate 24 is kept very small. In an embodiment a height of 25 micrometer is used. In other embodiment a height from a range between 10 micrometer to 300 micrometer and more preferably from a range between 10 and 100 micrometer may be used. The height of the gas channel is much higher, at least because of the height of the substrate portions 20 that are used to support sieve layer 22 (these may have a height of 675 micrometer for example). By providing the gas channel on the side of the surface of sieve layer 22 with substrate portions 20 and the liquid-channel on the side without such substrate portions 20 a liquid channel with such a small height is made possible.

It has been found that this enables very high mass transfer capacity characterised by relative small equilibrium length. The efficiency of a mass transfer device, such as a desorption device, with a liquid flow and a gas flow can be characterized by an equilibrium length, which is the length of liquid channel after which transfer equilibrium with the gas is obtained under prevalent liquid and gas flow conditions. An indication of this equilibrium length can be found by dividing the actual liquid flow velocity by a mass transfer coefficient. For conventional columns values could be found in the order of 100 mm, for the Cypes device this length is in the order of 50 mm. Values in the order of a few millimeters can be achieved by the present device with a microsieve.

The use of a mt-channel with such a small height has the effect that a mt-channel of small length (typically several millimeters) suffices before maximum possible transfer of a component from the volume of flowing liquid is realized.

The limiting effect of diffusion through the height of the channel is minimized by the small height of the channel. On the other hand, the small height results in considerable drag on liquid flow, which means that a relatively large pressure is needed to realize sufficient flow. By using holes of small size in sieve layer 22 it is prevented that this liquid flows through the holes. The small size of the holes ensures that a relatively large threshold is realized that must be exceeded by the pressure difference between the liquid and the gas before flow occurs through the holes. A pressure difference selected from a range between 5 to 60 kPa and more preferably 5 to 30 kPa between the pressures at the gas channel and the liquid channel part along sieve layer 22 may be used for example. This has been found to make it possible to apply sufficient pressure to produce a practical flow in both liquid and gas channel, moreover the application of the shorter channels makes is possible to allow for relative high liquid flows. More generally, a pressure difference for use during operation may be selected experimentally, by applying different pressure differences between the fluids on opposite sides of the microsieve and detecting whether products of fluid flow through the microsieve are present in the fluids at these pressure differences. Thus a pressure difference may be selected at which no flow of the fluid through the microsieve occurs, and the selected pressure difference may be applied during normal operation.

Moreover the length of the pores also plays an important role in the local transfer and transport efficiency. In principle the mass transfer capacity is governed by the successive transfer coefficients from diffusion through the liquid, transfer through the membrane and transfer from liquid to gas. While the last component can mostly be neglected the transfer through the membrane is strongly dependent on the membrane, at least when holes of relatively small diameter are used, which are comparable to or smaller than the depth of the holes. In this case transfer through the membrane should be taken into account for the operation of microfluidic devices. Surprisingly it has been found that application of the thin microsieve layer thickness as described strongly reduces the effect of the membrane on the mass transfer from the liquid to the gas in case of desorption even though the aggregate hole size per unit area in the microsieve surface 22 is as low as 10%. By using a very thin sieve layer 20, a significant reduction of the effect of transfer through the membrane can be achieved.

In an embodiment the threshold for flow through the holes can be raised by applying a hydrophobic layer at least to the liquid side surface of sieve layer 22 and to the walls of the holes in sieve layer 22. A fluoropolymer may be applied for example (an example is Teflon (R), available from Du Pont). A sputtering process or vapor deposition with hydrophobic material may be used for example, after the holes have been etched, preferably when the substrate layer has been removed in the openings between substrate portions 20. This improves coverage of the walls of the holes. The hydrophobic layer serves to increase the threshold that must be exceeded by the pressure difference between liquid phase and gas phase before flow occurs through the holes.

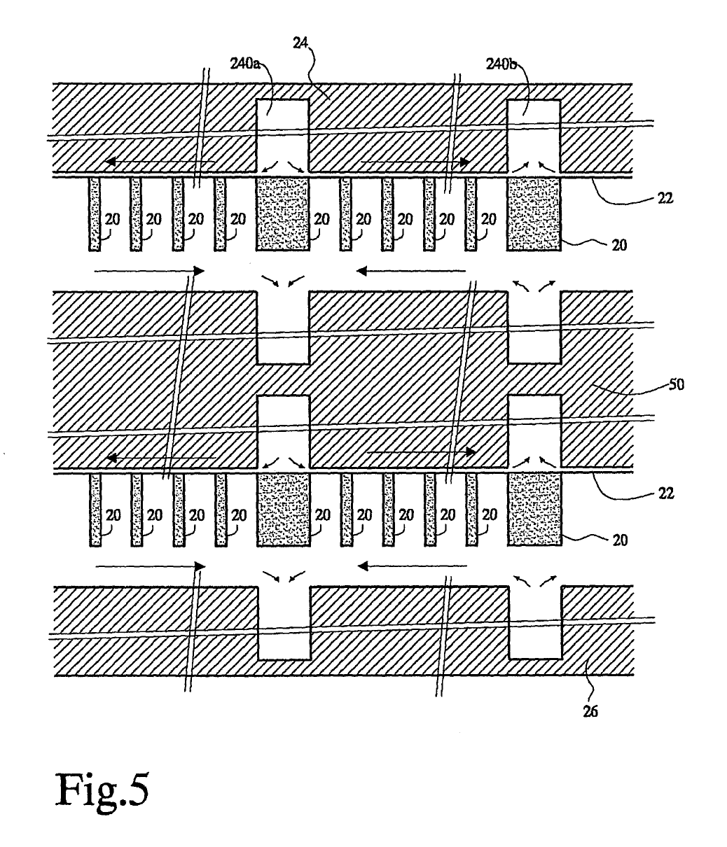

FIG. 5 shows an embodiment of separation unit 14 with a stack of microsieves and channel plates. In this embodiment, first and second channel plates are combined, to form a double sided channel plate 50 with grooves and ridges on two sides a shared second wall, for use by adjacent microsieves. In operation liquid and gas are fed to grooves adjacent all microsieves in the stack. By way of example a stack comprising two microsieves is shown, but it should be understood that any plurality of double sided channel plates 50 may be used with microsieves in between. In this way a very compact high capacity desorption unit may be formed. Alternatively, double sided channel plates may be used that combine the grooves and protrusion of a first channel plate 24. The may be used alternatingly with further double sided channel plates that combine the grooves and protrusion of a second channel plate 26, the substrate portions 20 of successive microsieves alternately facing in mutually opposite directions.

An embodiment has been described using a gas flow and a liquid flow separated by a microsieve, which allows transfer between the liquid and gas that both flow along the microsieve, with a flow directed substantially along virtual planes parallel to the surface of the microsieve (here with “substantially”, is meant that the overall flow directions from where the fluid is introduced adjacent the microsieve to where it is removed are parallel, thus disregarding local hydrodynamic effects that result in locally different currents whirls, such as the effects of the openings). The flows in the planes may be parallel, antiparallel or crossed. But it should be appreciated that more generally a microsieve may be used to separate two flowing fluids (gas or liquid) that flow along the microsieve on either side of the microsieve, to allow for mass transfer between the fluids through straight holes through the microsieve. If the same type of fluid (liquid or gas) flows on both sides of the microsieve, channels of more similar height may be used on either side of the microsieve. This can be applied to realize desorption, as shown in the embodiment, but equivalently absorption or distillation may be realized. Although the maximum achievable fraction of aggregate hole area per unit area of the microsieve may be expected to be less than is possible with thicker sieve layer, the use of a very thin layer makes it possible to make more efficient use of the holes in the sieve layer. It has been found that the use of the very thin sieve layer with microscopic holes straight through the sieve layer made possible by the use of a microsieve makes it possible to increase the mass transfer efficiency, such as desorption efficiency.

1. A mass transfer device for transferring a component from a first fluid into a second fluid, the mass transfer device comprising a first channel with a first inlet and outlet for the first fluid and a second channel with a second inlet and outlet for the second fluid and a microsieve separating the first and second channel, the microsieve comprising a sieve layer with a thickness of less than two micrometer deposited on a substrate with openings to expose areas of the sieve layer with holes straight through the sieve layer, interconnecting the first and second channel.

2. A mass transfer device according to claim 1, which is a desorption device, comprising a liquid source coupled to the first inlet and a gas source coupled to the second inlet, so that the first fluid is a liquid and the second fluid is a gas, the first channel being a liquid and the second fluid being a gas channel.

3. A mass transfer device according to claim 1, comprising a channel plate located adjacent the microsieve, the sieve layer having mutually opposite first and second surfaces, the second surface having a part supported by the substrate, the first and second fluid inlet feeding to the first and second surface respectively, said channel plate facing the first surface of the sieve layer, the channel plate comprising a groove that defines the first channel located between the channel plate and the first surface of the sieve layer, overlying the part of the second surface of the sieve layer that is supported by the substrate, and the first fluid inlet feeding to the groove.

4. A mass transfer device according to claim 3, wherein a height between the sieve layer and a part of the channel plate facing the areas exposed by the openings in the substrate is less than three hundred micrometers.

5. A mass transfer device according to claim 4, wherein a height between the sieve layer and a part of the channel plate facing the exposed areas is less than a hundred micrometers.

6. A mass transfer device according to claim 3, wherein the channel plate comprises a plurality of grooves, each overlying a respective part of the sieve layer that is supported by the substrate, the grooves coupling the fluid inlet and/or a fluid outlet to the channels between the channel plate and the first surface of the sieve layer at the areas exposed by the openings in the substrate.

7. A mass transfer device according to claim 6, comprising a series of successive grooves that run at least partly in parallel, alternating ones of the series of grooves being coupled to the liquid inlet and the liquid outlet respectively.

8. A mass transfer device according to claim 3, comprising a further channel plate located facing the substrate and the second surface of the sieve layer, the second fluid inlet feeding to a further channel between the channel plate on one hand and the substrate and the second surface of the sieve layer on the other hand.

9. A mass transfer device according to claim 8, comprising a stack of microsieves separated by successive channel plates.

10. A mass transfer device according to claim 1, the sieve layer having mutually opposite first and second surfaces, the second surface having a part supported by the substrate, comprising a hydrophobic layer deposited on a first surface of the sieve layer.

11. A method of transferring mass between a first and second fluid, the method comprising creating a first and second flow of the first and second fluid respectively, directed along substantially parallel virtual planes on mutually opposite sides of a microsieve with a sieve layer with a thickness of less than two micrometer deposited on a substrate with openings to expose areas of the sieve layer with holes straight through the sieve layer.

12. A method according to claim 11, the sieve layer having mutually opposite first and second surfaces, the second surface having a part supported by the substrate, the holes running from the first surface to the second surface, the method comprising feeding the first fluid into a channel adjoining the first surface opposite the part of the first surface that is supported by the substrate, and guiding the first flow along the sieve layer from the channel along a further part of the sieve layer that is exposed by the openings.

13. A method according to claim 12, wherein said channel has a height over the first surface of less than three hundred micrometer.

14. A method according to 11, wherein a pressure difference with a value in a range of 5-60 kPa and more preferably in a range of 5-30 kPa is applied between the fluids applied on opposite sides of the sieve layer.
